(19) United States
(12) Patent Application Publication
(10) Pub. No.: US 2009/0188735 A1
(43) Pub. Date: Jul. 30, 2009

(54) Connecting Structure between the Retaining Tabs on the Side Plates and the Cooling Fins of an Automotive Heater Core

(76) Inventor: Huixin Xu, Jiangyin (CN)

Correspondence Address: GLOBAL IP SERVICES, 7285 W. Eagle Court, Winton, CA, 95388, US

(21) Appl. No.: 12/361,544

(22) Filed: Jan. 29, 2009

(30) Foreign Application Priority Data
Jan. 30, 2008 (CN) 200810018986.X

(51) Int. Cl. B60K 11/04

(52) U.S. Cl. 180/68.4

(57) ABSTRACT

This invention involves a coordinative structure between the retaining tabs on the side plates and the cooling fins of an automotive heater core, which belongs to the field of auto parts technology. Said structure includes the side plates (5) and the cooling fins (7), characteristics of said structure are that there are two retaining tabs (5.2) at both ends of the side plates (5) where the ends of cooling fins (7) are. This coordinative structure prevents the cooling fins from touching the header while increases the friction between the cooling fins and side plates, it keeps the cooling fins from partially melting, burning and dropping out during the brazing process, thus ensures the brazing quality.

### CROSS REFERENCE TO THE RELATED PATENT APPLICATION

This application claims the priority of the Chinese patent application No. 200810018986.X filed on Jan. 30, 2008, which application is incorporated herein by reference.

### FIELD OF THE INVENTION

The invention involves an automotive heater core with a coordinative structure between the retaining tabs on the side plates and the cooling fins. It belongs to the field of auto parts technology.

### BACKGROUND OF THE INVENTION

An automotive heater core is a radiator dissipating heat into the car cabin using cooling water from the engine, it includes: inlet pipe, outlet pipe, upper tank, bottom tank, header, tube, cooling fins and side plate. During the brazing process, as the materials used for cooling fins and header plate are different, they require different brazing temperature, thus the cooling fins are often melted where they contact the header, which affects adversely the effective cooling area and the appearance and quality of the products, and often the cooling fins drop out during brazing.

### SUMMARY OF THE INVENTION

The purpose of this invention is to overcome the above shortages, and to provide a coordinative structure between the retaining tabs on the side plates and the cooling fins of an automotive heater core to prevent the partial melting, burning and the dropping out of the cooling fins during brazing.

The purpose is achieved through the coordinative structure between the bending tips on the side plates and the cooling fins of an automotive heater core including side plate (5) and cooling fins (7). It has the characteristics that described side plate (5) has two retaining tabs at both ends of the side plates where the cooling fins (7) end.

By using this structure the cooling fins are kept from touching the header and the friction between the cooling fins and side plates is enhanced so that partial melting, burning and dropping of the cooling fins are prevented to ensure brazing quality.

### BRIEF DESCRIPTION OF THE DRAWINGS

FIG. 1 shows the overall structure of the automotive heater core involved in this invention

FIG. 2 shows the two retaining tabs at both ends of the side plates of the automotive heater core

FIG. 3 shows the positioning of the 2 retaining tabs on the side plates of the automotive heater core where the cooling fins end.

In the drawings: inlet pipe 1, outlet pipe 2, upper tank 3, header 4, side plate 5, tube 6, cooling fins 7, bottom tank 8, and retaining tabs 5.2.

### DETAIL DESCRIPTION OF THE INVENTION

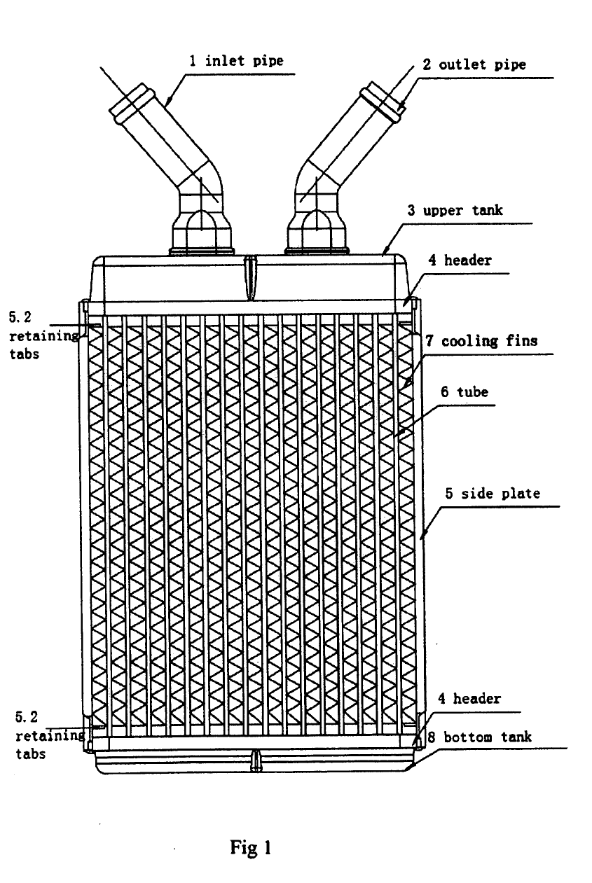

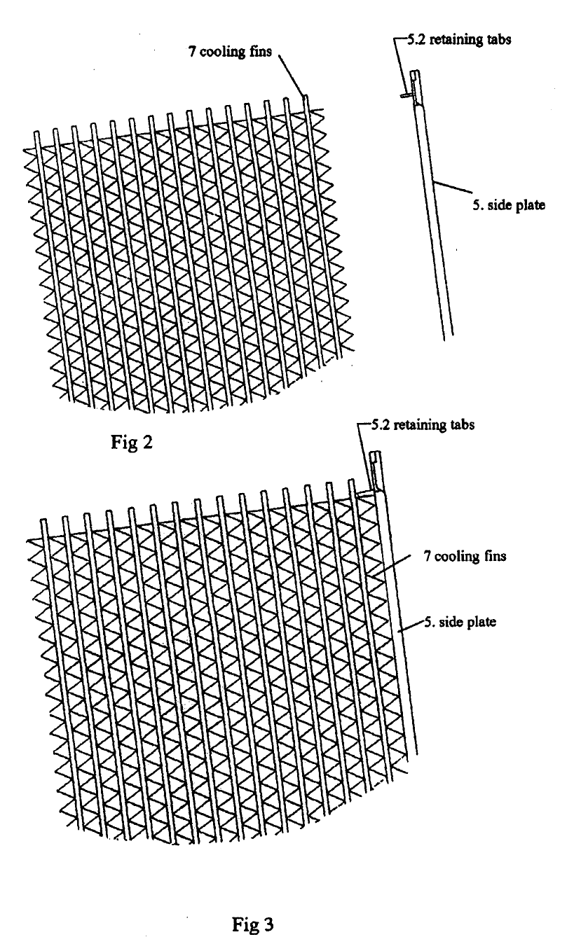

In reference to FIG. 1, an automotive heater core includes eight parts: inlet pipe 1, outlet pipe 2, upper tank 3, bottom tank 8, header 4, tube 6, cooling fins 7 and side plate 5. Described side plate 5 has two retaining tabs 5.2 (at both ends of the side plates as indicated on the drawing) where the cooling fins (7) end, as shown in FIGS. 2, 3 and 4.

What is claimed is:

1. A connecting structure between retaining tabs on the side plates and cooling fins of an automotive heater core comprising side plates and cooling fins, each side plate has two retaining tabs at both ends thereof, where the ends of the cooling fins are.
